(19) United States
(12) Patent Application Publication
(10) Pub. No.: US 2026/0002486 A1
(43) Pub. Date: Jan. 1, 2026

(54) SYSTEMS AND METHODS FOR OCTANE NUMBER RATING WITH ELECTRONIC FUEL INJECTION

(71) Applicant: CFR Engines Inc., Pewaukee, WI (US)

(72) Inventor: Michael Pitcel, Pewaukee, WI (US)

(73) Assignee: CFR Engines Inc., Pewaukee, WI (US)

(21) Appl. No.: 19/253,449

(22) Filed: Jun. 27, 2025

Related U.S. Application Data
(60) Provisional application No. 63/665,727, filed on Jun. 28, 2024.

(51) Int. Cl. F02D 41/30

(52) U.S. Cl. CPC F02D 41/3082

(57) ABSTRACT

An electronic fuel injection system for an octane number rating system includes an electronic fuel pump, an electronic fuel injector in fluid communication with an outlet of the electronic fuel pump, and an air-fuel ratio sensor configured to measure an air-fuel ratio within or downstream of an exhaust port. The electronic fuel pump is configured to supply pressurized fuel from a carburetor bowl to the electronic fuel injector, and the electronic fuel injector is coupled to the intake pipe upstream of the venturi.

### CROSS-REFERENCE TO RELATED PATENT APPLICATIONS

This application claims the benefit of and priority to U.S. Provisional Patent Application No. 63/665,727, filed on Jun. 28, 2024, which is incorporated herein by reference in its entirety.

### BACKGROUND

The octane rating for a spark-ignition engine fuel is represented by an octane number scale, which is typically represented as an average of the research octane number and the motor octane number, that ranges from 0 to 120 and provides an indication of the fuel's antiknock index.

### SUMMARY

In some aspects, the present disclosure relates to an electronic fuel injection system for an octane number rating system, the octane number rating system including an octane test engine having an intake pipe, an exhaust port, and a carburetor with a venturi arranged downstream of the intake pipe, the electronic fuel injection system including: an electronic fuel pump; an electronic fuel injector in fluid communication with an outlet of the electronic fuel pump, wherein the electronic fuel pump is configured to supply pressurized fuel from a carburetor bowl to the electronic fuel injector, and wherein the electronic fuel injector is coupled to the intake pipe upstream of the venturi; and an air-fuel ratio sensor configured to measure an air-fuel ratio within or downstream of the exhaust port.

In some aspects, the present disclosure relates to a method for determining an octane number of a sample fuel, the method including: instructing an octane test engine to operate at a first air-fuel ratio; controlling an electronic fuel injector so that the octane test engine operates at the first air-fuel ratio; measuring an operating air-fuel ratio of the octane test engine with an air-fuel ratio sensor; measuring a first knock intensity that corresponds with the first air-fuel ratio; instructing the octane test engine to operate at a second air-fuel ratio; changing, via the electronic fuel injector, operation of the octane test engine so that the octane test engine operates at the second air-fuel ratio; measuring a second knock intensity that corresponds with the second air-fuel ratio; continuing to change the operating air-fuel ratio of the octane test engine, via the electronic fuel injector, until a maximum knock intensity is detected.

In some aspects, the present disclosure relates to a method for determining an octane number of a sample fuel, the method including: operating an octane test engine at an initial air-fuel ratio; measuring a first knock intensity that corresponds with the initial air-fuel ratio; decreasing, via an electronic fuel injector, an air-fuel ratio to a second air-fuel ratio; measuring a second knock intensity that corresponds with the second air-fuel ratio; measuring a slope of a line that includes the first knock intensity and the second knock intensity; determine an amount to decrease the air-fuel ratio based on the slope of the line; and decreasing, via the electronic fuel injector, the air-fuel ratio by the amount to a third air-fuel ratio; measuring a third knock intensity that corresponds with the third air-fuel ratio; and continuing to iteratively increase, via the electronic fuel injector, the air-fuel ratio based on a slope of a line that includes two most-recent knock intensities until the slope of the line becomes negative, wherein the amount that the air-fuel ratio increases becomes smaller as the slope of the line approaches zero.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of an octane number rating system, according to an exemplary embodiment;

FIG. 2 is a schematic illustration of a combustion chamber within an octane test engine of the octane number rating system of FIG. 1;

FIG. 3 is a block diagram of the octane test engine of the octane number rating system of FIG. 1;

FIG. 4 is a schematic illustration of a venturi and a fuel injector of the octane test engine of FIG. 1;

FIG. 5 is a block diagram of an electronic fuel injection system of the octane number rating system of FIG. 1;

FIG. 6 is a schematic illustration of a fuel delivery circuit of the electronic fuel injection system of FIG. 5;

FIG. 7 is a bottom perspective view of a fuel selector valve of the fuel delivery circuit of FIG. 6;

FIG. 8 is a perspective view of an intake pipe and an injector coupling assembly of the octane test engine of FIG. 1;

FIG. 9 is perspective view of the intake pip and the injector coupling assembly of FIG. 9 with the injector pipe being transparent;

FIG. 10 is a side view of the intake pip and the injector coupling assembly of FIG. 9 with the injector pipe being transparent;

FIG. 11 is a perspective view of a mounting cabinet of the octane number rating system of FIG. 1;

FIG. 12 is a front view of the cabinet of FIG. 11 with a front door removed;

FIG. 13 is a bottom view of the cabinet of FIG. 11;

FIG. 14 is a schematic illustration of a fuel delivery circuit of the electronic fuel injection system of FIG. 5 including individual fuel pumps for each carburetor bowl;

FIG. 15 is a front view of an octane number rating system of FIG. 1 including the fuel delivery circuit of FIG. 14;

FIG. 16 is a perspective view the octane number rating system of FIG. 15;

FIG. 17 is a rear perspective view of the octane number rating system of FIG. 15; and

FIG. 18 is a schematic illustration of a control system of the octane number rating system of FIG. 1.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The use of the terms “downstream” and “upstream” herein are terms that indicate direction relative to the flow of a fluid. The term “downstream” corresponds to the direction of fluid flow, while the term “upstream” refers to the direction opposite or against the direction of fluid flow.

The standard test method or procedure for determining an octane number of spark-ignited engine fuel is governed by both ASTM D2699 and ASTM D2700, with ASTM D2699 outlining the test procedure for the research octane number (RON) and ASTM D2700 outlining the test procedure for the motor octane number (MON). The RON procedure is performed at more mild engine conditions (e.g., lower speed) than the MON procedure, and the RON and MON values are typically averaged ((RON+MON)/2) to generate an overall octane number for the fuel (e.g., a value shown at a gas pump). The conventional test setup for conducting ASTM D2699 and ASTM D2700 includes a carburetor fuel system that delivers fuel to a single-cylinder test engine. The carburetor fuel system includes a four-bowl carburetor where a selection valve supplies the fuel from a selected one of the carburetor bowls to a venturi where it is mixed with intake air and then drawn into to the combustion chamber. The fuel level supplied to the engine by the carburetor fuel system is either controlled manually by adjusting a fuel level knob or allowed to naturally fall (i.e., decrease in supply to lean out the air-fuel mixture), and the measurement of the fueling level being supplied to the engine is manually read off of a sight glass that corresponds to the selected carburetor bowl supplying the fuel. The sight glass measures the head pressure of the fuel being supplied to the venturi and shows the level below the venturi of the carburetor in tenths of an inch. Accordingly, the sight glass measurement of fuel level provides a qualitative indication of whether fuel level is increasing or decreasing, but does not provide a quantitative value for the fuel flow rate being supplied to the engine.

During the ASTM D2699 and ASTM D2700 procedures, the fuel level is adjusted, either manually or by allowing it to fall, to find a maximum knock intensity that is measured by a knock sensor. The maximum knock index of a sample fuel is compared to two reference fuels with known octane numbers, and the octane number of the sample fuel is iterated based on the known octane numbers of the reference fuels and the maximum knock index of the sample fuel. Due to the qualitative sight glass measurement of fuel level, the octane number for the sample fuel cannot be correlated to a standardized engine parameter (e.g., air-fuel ratio (AFR)). Additionally, the manual or falling level adjustment of the fuel level does not provide a very granular adjustment in the fuel level and also does not allow selective variability in the fuel level step changes (e.g., smaller adjustments as the knock intensity approaches the maximum value and larger steps away from the maximum value).

The accuracy of the octane number determined by ASTM D2699 and ASTM D2700 and the precision (e.g., repeatability) with which the octane number procedure is carried out have a significant impact on automotive/research industries and the fuel supply chain (e.g., refineries). For example, producing accurate and precise octane number results enables automotive/research industries to effectively test new fuel blends. Also, the fuel supply chain business is heavily dependent on the accuracy of the octane number so refined fuels may be accurately categorized and sold according to the fuel quality (i.e., octane number) determined by ASTM D2699 and ASTM D2700.

The systems and methods of the present disclosure provide an electronic fuel injection system that greatly improves the precision, accuracy, operator efficiency, and repeatability between different testing/research facilities of the ASTM D2699 and ASTM D2700 octane number procedure. In some embodiments, the electronic fuel injection system includes one or more electronically-driven high-pressure pumps that supply high-pressure fuel to an electronic fuel injector. The electronic control of the high-pressure pump(s) and the fuel injector enables the fuel flow rate, the SOI, the injection duration, and the injection quantity to be set electronically, which removes the need for manual adjustment of these parameters required in the conventional fuel system. Additionally, the electronic fuel injection system includes a AFR sensor (e.g., a wide-band O₂ sensor) that allows the AFR to be directly measured, correlated to knock intensity, and used to determine the fuel step changes during the ASTM D2699 and ASTM D2700 procedures. Additionally, the incorporation of the AFR sensor allows the system to compensate for oxygenated fuel, elevation changes, and intake air temperatures by commanding a specific AFR and adjusting the electronic fuel injector (e.g., adjusting a pulse-width of the injector) to meet the commanded AFR. In some embodiments, either in addition to or alternatively to, the electronic fuel injection system may include a fuel flow meter that directly measures the fuel flow rate and a mass air flow sensor that directly measures intake air flow rate, which, when combined with the fuel flow rate, may be used to directly calculate AFR.

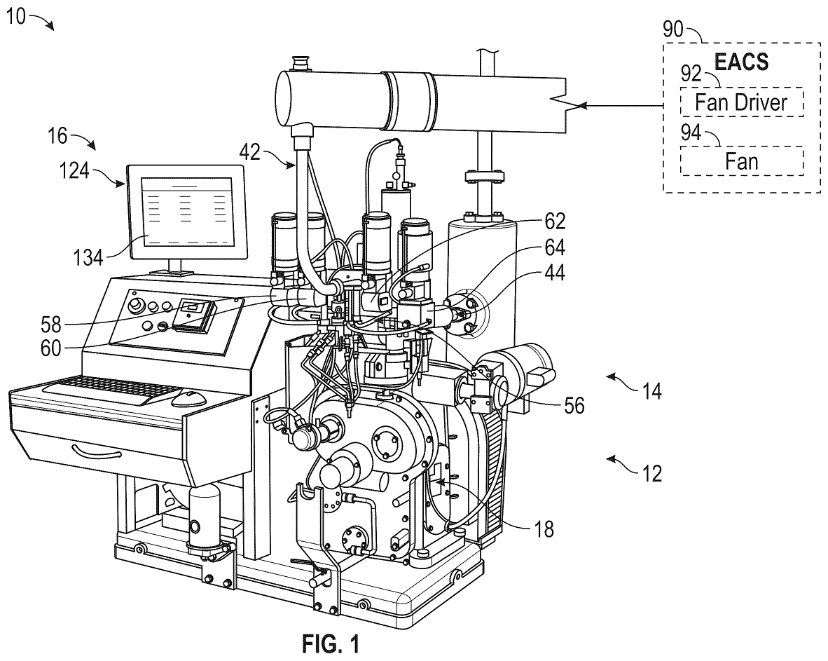

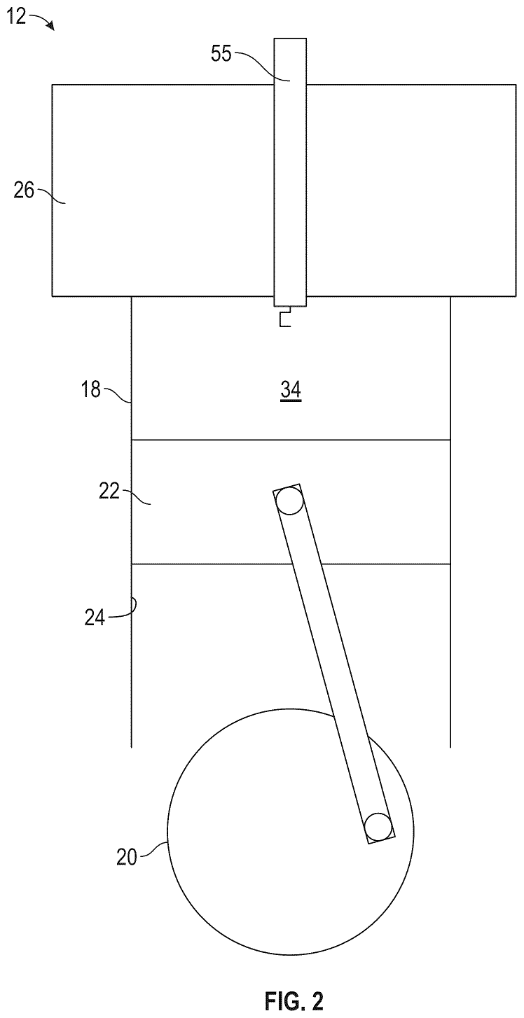

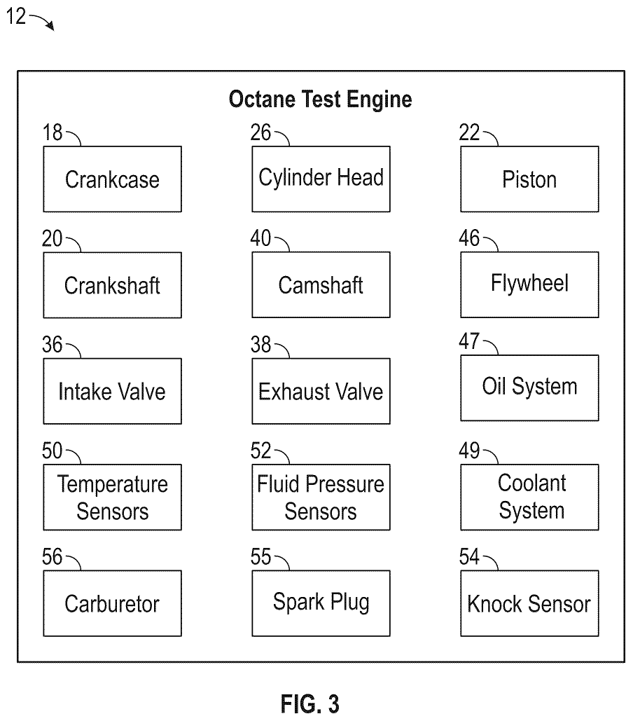

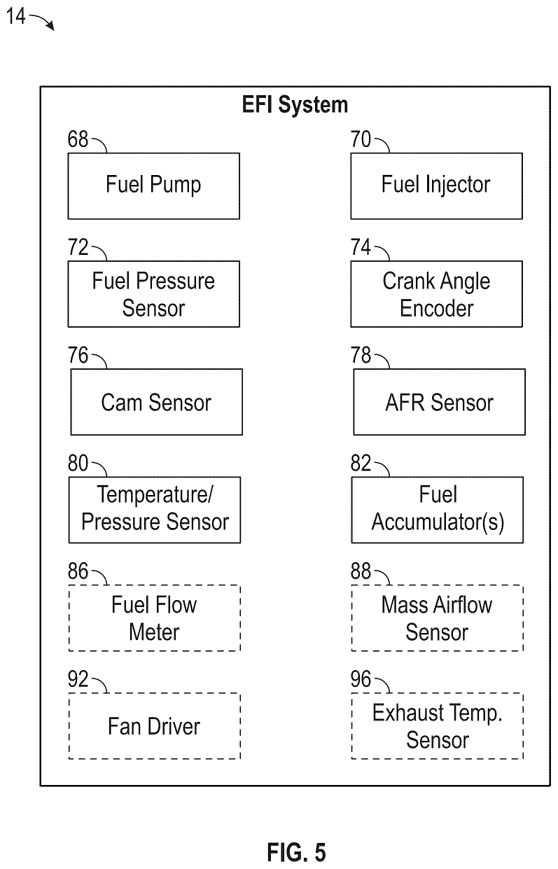

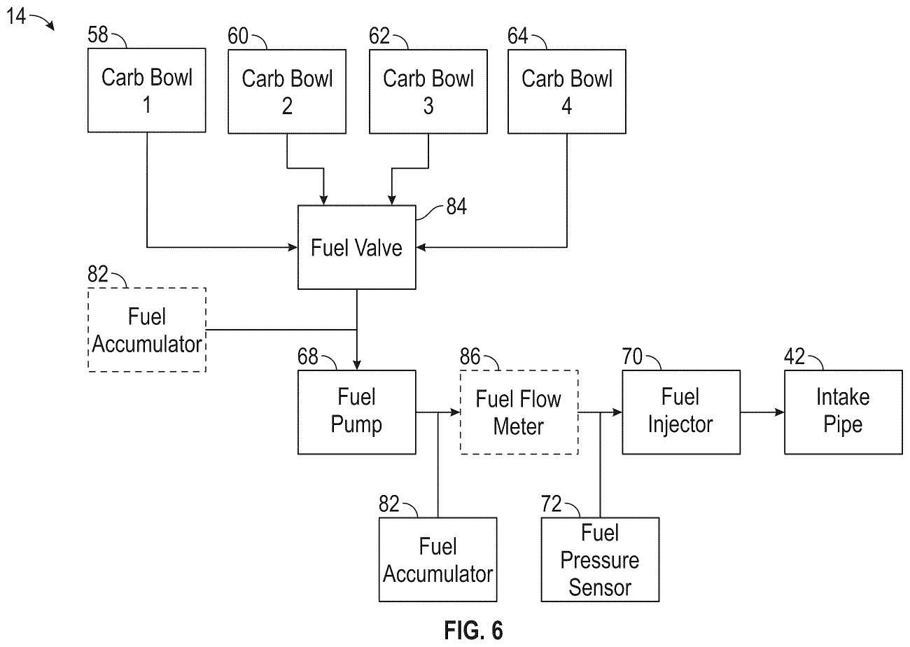

FIGS. 1-6 show an octane number rating system 10 that is used to determine an octane number of a sample fuel relative to two primary reference fuels according to ASTM D2699 and ASTM D2700. The octane number rating system 10 includes an octane test engine 12, an electronic fuel injection (EFI) system 14, and a human-machine interface (HMI) 16. In some embodiments, the octane test engine 12 is a single-cylinder, four-stroke cycle, variable compression ratio, carbureted, spark-ignition engine. In some embodiments, the octane test engine 12 is a model F1/F2 engine unit manufactured by CFR Engines Inc.

With specific reference to FIGS. 1-3, the octane test engine 12 includes a crankcase 18 that encloses a crankshaft 20. The crankshaft 20 is rotatably coupled to a piston 22 so that rotation of the crankshaft 20 results in reciprocal motion of the piston 22 within a cylinder bore 24 defined within the crankcase 18. A cylinder head 26 is coupled to a top side of the crankcase 18. In general, the volume within the cylinder bore 24 between the piston 22 and the cylinder head 26 is defined as a combustion chamber 34 (e.g., a main combustion chamber). In some embodiments, an intake valve 36 and an exhaust valve 38 are housed within the cylinder head 26. The intake valve 36 is configured to selectively open and provide intake air from an intake conduit or pipe 42 to the combustion chamber 34 based on the timing governed by rotation of a camshaft 40. The exhaust valve 38 is configured to selectively open and provide exhaust gases from the combustion chamber 34 to an exhaust conduit 44 based on the timing governed by rotation of the camshaft 40. The camshaft 40 is rotatably coupled to the crankshaft 20 (e.g., via a geartrain) so that two rotations of the crankshaft 20 result in one rotation of the camshaft 40 and the octane test engine 12 operates on a four-stroke engine cycle (intake stroke, compression stroke, power stroke, exhaust stroke). A spark plug 55 extends through the cylinder head 26 and into the combustion chamber 34. The spark plug 55 is configured to generate a spark (e.g., an arc) at a particular crank angle position (e.g., thirteen degrees before top dead center (bTDC)).

In some embodiments, the octane test engine 12 includes a flywheel 46 rotatably coupled to the crankshaft 20 so that rotation of the crankshaft 20 results in rotation of the flywheel 46. In some embodiments, the octane test engine 12 includes an oil system 47 (e.g., an oil pump and an oil filter) that provides lubricating oil to various components within the crankcase 18 and the cylinder head 26. In some embodiments, the octane test engine 12 includes a cooling system 49 allows the water to boil within the cylinder bore 24 and cylinder head 26. The water vapor rises up in a cooling tower to a condenser coil where it is cooled and the cooled water condenses and enters in at the bottom of a coolant passage in the cylinder bore 24. The water flows through the cylinder head 26 by a natural convection process.

In general, the octane test engine 12 includes a plurality of instrumentation sensors that are configured to measure engine operating parameters and communicate the engine operating parameters to the HMI 16. For example, the octane test engine 12 includes a plurality of temperature sensors 50, a plurality of fluid pressure sensors 52, and a knock sensor 54. In some embodiments, the temperature sensors 48 include an oil temperature sensor, an intake air temperature sensor, an exhaust gas temperature sensor, and a coolant temperature sensor. In some embodiments, the fluid pressure sensors 52 include an oil pressure sensor, a crankcase pressure sensor, a coolant pressure sensor, and an intake air pressure sensor. In some embodiments, the knock sensor 54 is in the form of an in-cylinder pressure sensor that is configured to measure the pressures within the combustion chamber 34 while the octane test engine 12 is running (e.g., during the four-stoke cycle). The pressure signal measured by the knock sensor 54 may be filtered to identify a particular frequency band that is associated with knock to produce a knock intensity value. In some embodiments, the knock sensor 54 is in the form of a vibration sensor that is configured to measure vibration within a particular frequency band that is associated with knock to produce a knock intensity value. Regardless of the particular configuration defined by the knock sensor 54, the knock sensor 54 is configured to output a signal that is filtered and a knock intensity value is calculated based on the filtered signal and is used to determine the octane number of a sample fuel during the ASTM D2699 and ASTM D2700 procedures.

As shown in FIGS. 1, 3, and 4, one of four fuels is supplied to the octane test engine 12 by a carburetor 56 that includes four carburetor bowls 58, 60, 62, 64 and a venturi 66 arranged downstream of the intake pipe 42. In a conventional octane test engine 12, the carburetor 56 includes a fuel discharge nozzle that is in fluid communication with the venturi 66 so that the venturi 66 draws fuel from one of the selected carburetor bowls 58, 60, 62, 64 (e.g., based on a position of a fuel selector valve) and supplies an air-fuel mixture to the intake valve 36 and then to the combustion chamber 34 during the intake stroke. The octane number rating system 10 of the present disclosure includes the EFI system 14 that enables the electronic control and adjustment of the fuel supplied to the octane test engine 12, in addition to the active measurement of various engine operating parameters (e.g., AFR). In some embodiments, the carburetor bowls are in the form of fuel reservoirs and the octane test engine 12 may not include the carburetor 56.

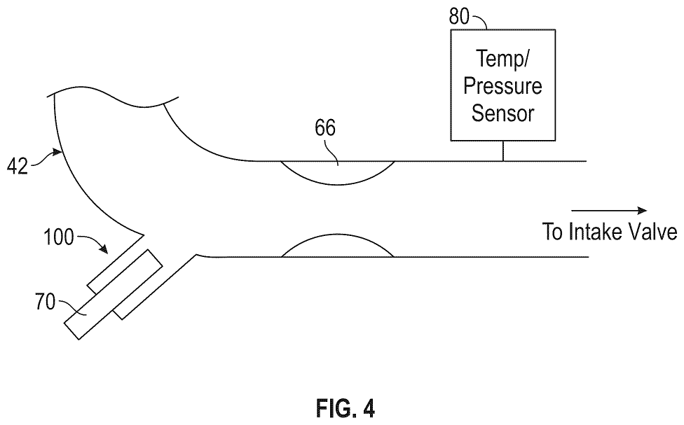

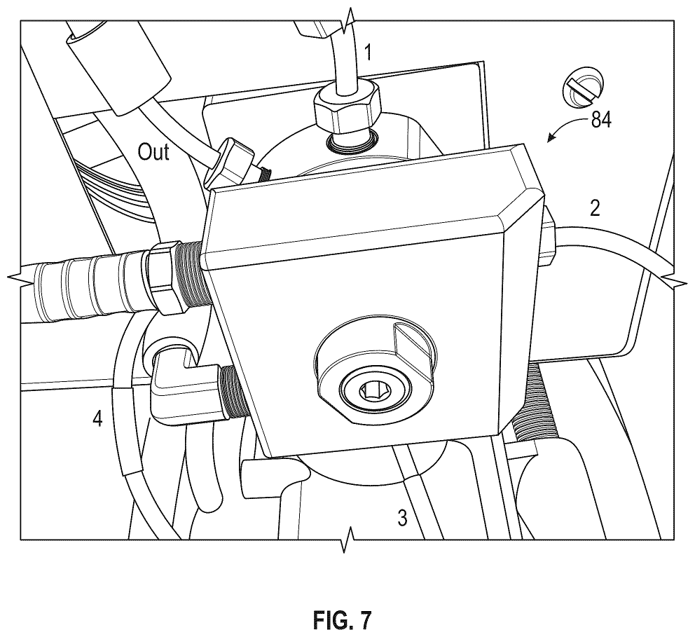

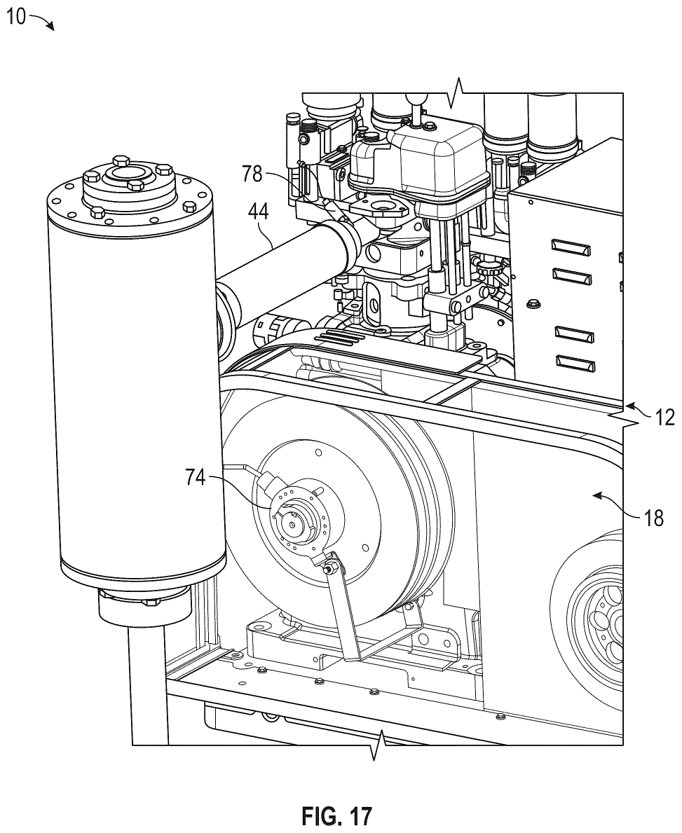

In some embodiments, the EFI system 14 is a retrofit kit that may be installed on a conventional octane test engine so that a user may still use the carbureted procedures for determining octane number outlined in ASTM D2699 and ASTM D2700 or the EFI-based measurements/procedures described herein. Turning to FIGS. 4-6, the EFI system 14 includes a fuel pump 68, a fuel injector 70, a fuel pressure sensor 72, a crank angle encoder 74 (see, e.g., FIG. 17), a cam sensor 76, an AFR sensor 78, a temperature/pressure sensor 80, and one or more fuel accumulators 82. In general, each of the carburetor bowls 58-64 is in fluid communication with a fuel selector valve 84. The fuel selector valve 84 includes four inlets (one for each of the carburetor bowls 58-64) and an outlet that is in fluid communication with an inlet of the fuel pump 68 (see, e.g., FIG. 7). The fuel selector valve 84 is configured to selectively provide fluid communication between one of the carburetor bowls 58-64 and the inlet of the fuel pump 68, for example, based on a user input received from the HMI 16. In some embodiments, the fuel selector valve 84 is configured to selectively provide one of three fuels, from one of three fuel reservoirs, to the fuel injector 70.

In some embodiments, the fuel pump 68 is a fluid metering valveless piston pump. The fuel pump 68 is configured to receive a selected fuel from the fuel selector valve 84 and supply the fuel at increased pressure to a pump outlet that is in fluid communication with the fuel injector 70. In some embodiments, the fuel injector 70 is an electronic solenoid-style fuel injector. In some embodiments, the EFI system 14 may include a fuel flow meter 86 arranged between the fuel pump 68 and the fuel injector 70 that is configured to measure a fuel flow rate (e.g., mass flow rate) supplied to the octane test engine 12 by the fuel injector 70. The fuel pressure sensor 72 is configured to measure the fuel pressure upstream of the fuel injector 70 (e.g., in between the fuel pump 68 and the fuel injector 70). In the illustrated embodiment, the EFI system 14 includes a fuel accumulator 82 arranged downstream of the fuel pump 68. In general, the fuel accumulator 82 is configured to dampen pressure oscillations that occur in the EFI system 14 during operation. In some embodiments, the EFI system 14 may include a first fuel accumulator 82 arranged downstream of the fuel pump 68 and a second fuel accumulator 82 arranged upstream of the fuel pump 68.

In general, during operation, the fuel pump 68 is controlled based on the fuel pressure measured by the fuel pressure sensor 72 to maintain a generally constant fuel pressure supplied to the fuel injector 70. In some embodiments, pulse-width-modulation (PWM) control is supplied to the fuel pump 68 to maintain the fuel pressure. As the injection duration of the fuel injector 70 changes, the fuel pressure sensor 72 will detect a pressure change and will adjust the PWM of the fuel pump 68 accordingly. This pressure control arrangement eliminates the need to recirculate the fuel back to the inlet side of the fuel system with a pressure regulator.

In some embodiments, the EFI system 14 includes purging solenoids, with one of the solenoids would be positioned near the pump outlet and the other near the upstream side of the fuel injector 70. The solenoid near the fuel pump may be connected to pressurized air and the solenoid next to the injector may be connected a waste fuel container. During a fuel change over, the fuel pump 68 is instructed to stop pumping fuel, the solenoids both open, and the pressurized air purges the fuel lines. The solenoids would close and the fuel selector valve 84 is instructed to change over to the next fuel and the fuel pump 68 is instructed to start pumping new fuel into the octane test engine 12. A purge time is implemented to purge the fuel left before the fuel pump 68 but the time would be shortened during the change over, and the injector “ON” time is be maximized to purge any air as the fuel is refilled.

In addition to the fuel system components, the EFI system 14 provides instrumentation that facilitates control of the fuel injector 70 and the measurement of engine operating parameters that may be used in an octane rating procedure. For example, the crank angle encoder 74 is configured to measure a rotational position of the crankshaft 20 (e.g., crank angle degrees), which corresponds to a position of the piston 22 along the cylinder bore 24 during the four-stroke cycle. In some embodiments, the crank angle encoder 74 is an optical encoder. In some embodiments, the crank angle encoder 74 may be a timing wheel that is clocked to rotation of the crankshaft 20. In some embodiments, the crank angle encoder 74 is configured to measure engine speed (in revolutions per minute (RPM)) in addition to measuring the crank angle position. In general, the crank angle encoder 74 is configured to synchronize the speed of the octane test engine 12 with the timing events of the engine (e.g., fuel injection, spark timing, etc.). The cam sensor 76 may be an encoder or a hall effect sensor that is configured to detect to absence or presence of a single gear tooth that is timed to the camshaft 40. In general, the detection of the presence or absence of the gear tooth by the cam sensor 76 provides a signal indicative of intake and exhaust events, and this signal may be used to trigger injection by the fuel injector 70 (e.g., a predetermined number of crank angle degrees before the intake event).

In some embodiments, the AFR sensor 78 is a wide-band AFR sensor (e.g., wide-band O₂ sensor) that is configured to actively measure the AFR (or equivalence ratio) supplied to the octane test engine 12. The AFR sensor 78 may be installed on the exhaust port of the octane test engine 12, for example, upstream of the exhaust conduit 44 and downstream of the exhaust valve 38 (see, e.g., FIG. 17). Mounting the AFR sensor 78 in the exhaust port arranges the AFR sensor 78 in a location with the hottest exhaust temperatures (outside of the combustion chamber 34) and will have the shortest amount of lag time between the AFR measurement and the knock intensity measurement from the knock sensor 54. In embodiments where the EFI system 14 includes the fuel flow meter 86, the EFI system 14 may also include a mass airflow sensor 88 arranged within the intake pipe 42 and configured to measure the mass flowrate of air supplied to the octane test engine 12. In this way, for example, the combined measurements from the fuel flow meter 86 and the mass airflow sensor 88 may allow the AFR to be directly calculated, either alternatively or additionally to the measurement from the AFR sensor 78.

The temperature/pressure sensor 80 is configured to measure the temperature and pressure downstream of the venturi 66 and upstream of the intake valve 36 (see, e.g., FIG. 4). In some embodiments, the temperature/pressure sensor 80 is in the form of a temperature manifold absolute pressure (TMAP) sensor. The values measured by the temperature/pressure sensor 80 may be used to assess the barometric conditions that the octane test engine 12 is being operated in and, in some embodiments, the EFI system 14 is configured to compensate for changes in the barometric conditions. For example, the octane test engine 12 may be configured to receive intake air that is treated by an engine air control system (EACS) 90 to control the temperature and relative humidity of the intake air supplied to the intake pipe 42. The EFI system 14 may include a fan driver 92 that is configured to supply pulse-width-modulation (PWM) control on a fan 94 within the EACS to offset changes in the intake air temperature that result from changes in the barometric pressure (e.g., as measured by the temperature/pressure sensor 80). In this way, for example, the EFI system 14 may compensate for changes in the barometric pressure, which has a large effect on the knock intensity measured by the knock sensor 54. In some embodiments, the fan driver 92 may be configured to control the fan 94 so that the fan 94 increases the pressure within the intake pipe 42 to simulate boosted operating conditions and enable the measurement of the knock intensity under boosted conditions at a particular AFR or a range of AFR's.

In some embodiments, the EFI system 14 may include the exhaust temperature sensor 96 that is configured to measure a temperature of the exhaust gases, for example, within the exhaust port where the AFR sensor 78 is arranged.

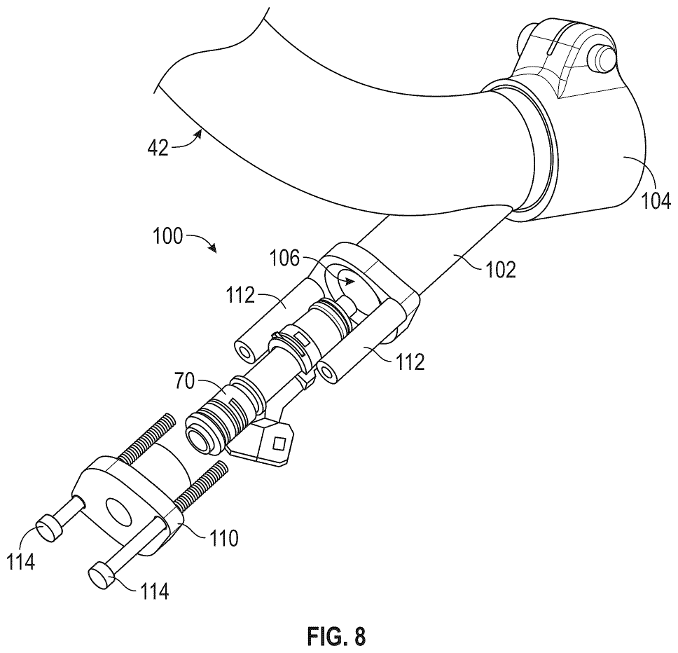

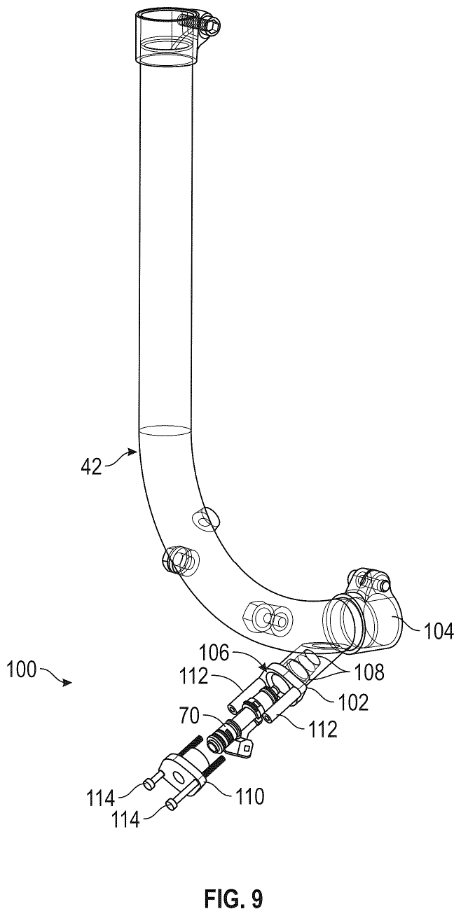

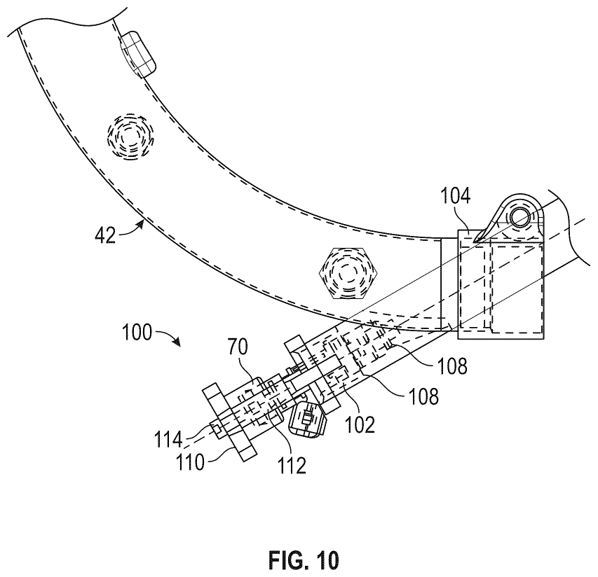

Turning to FIGS. 4 and 8-10, the fuel injector 70 is coupled to the intake pipe 42 upstream of the venturi 66. Specifically, the fuel injector 70 is coupled to the intake pipe 42 by an injector coupling assembly 100. In some embodiments, the combination of the intake pipe 42 and the injector coupling assembly 100 may form a modified intake pipe that may be installed on a conventional octane test engine as part of the EFI system 14 retrofit kit. In other words, the design and shape of the intake pipe 42 illustrated in FIGS. 8-10 are intended to mimic the intake pipe (e.g., J-pipe) on a conventional octane test engine and the injector coupling assembly 100 enables the fuel injector 70 to be installed on the octane test engine, without disrupting the carbureted operation of the engine (if a user wanted to perform carbureted octane number rating procedures) and enabling EFI operation to the utilized instead of carbureted operation. In some embodiments, the octane test engine 12 does not include the carburetor 56 and the venturi 66 and the fuel injector 70 is configured to supply fuel upstream of the intake valve 36.

The injector coupling assembly 100 includes an injector mounting pipe 102 that is coupled to the intake pipe 42, for example, adjacent to a carburetor inlet pipe 104 that is coupled to a downstream end of the intake pipe 42. In some embodiments, the injector mounting pipe 102 is fixedly coupled to the intake pipe 42 via a welding process. The injector mounting pipe 102 includes an internal bore 106 within which one or more injector seats 108 are arranged. When the fuel injector 70 in inserted within the internal bore 106, the fuel injector 70 may engage the one or more injector seats 108, and an injector mounting cap 110 may be installed on a top end (e.g., an end opposite to the injector nozzle) and secured by one or more fasteners to secure the fuel injector 70 within the injector mounting pipe 102. In the illustrated embodiment, a pair of spacers 112 are arranged between the injector mounting cap 110 and the injector mounting pipe 102, and a pair of threaded fasteners 114 (e.g., a screw, a bolt, etc.) extend through the injector mounting cap 110, through a respective one of the spacers 112, and threaded into the injector mounting pipe 102.

In some embodiments, the injector mounting pipe 102 is oriented at an angle A relative to a bottom surface defined by the carburetor inlet pipe 104 (e.g., parallel to a central axis defined by the carburetor inlet pipe 104). In some embodiments, the angle A is an acute angle. In some embodiments, the angle A is between about fifteen degrees and about sixty degrees. In some embodiments, the angle A is between about fifteen degrees and about forty five degrees. In some embodiments the angle A is about thirty degrees.

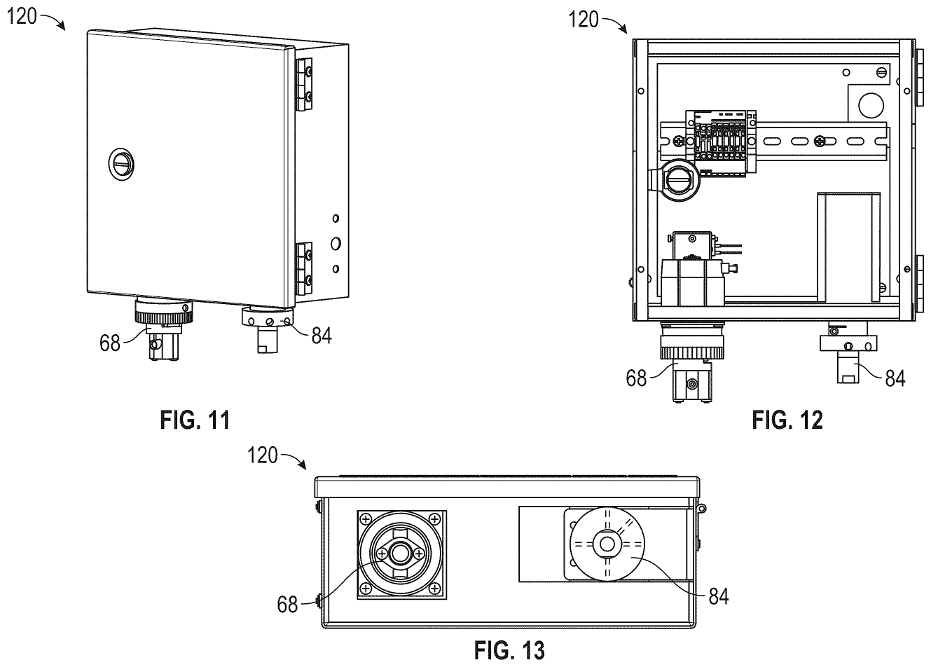

Turning to FIGS. 11-13, in some embodiments, the fuel pump 68 and the fuel selector valve 84 are at least partially housed within a cabinet or enclosure 120. In some embodiments, the cabinet 120 is mounted to a portion of the octane test engine 12 or a portion of an operator console on which the HMI 16 is mounted. In the illustrated embodiment, at least a portion of both the fuel pump 68 and the fuel selector valve 84 extend through and outwardly from a bottom surface of the cabinet 120. In some embodiments, the fuel pump 68 and the fuel selector valve 84 may be completely enclosed within the cabinet 120 and the fuel lines may extend into and out of the cabinet 120.

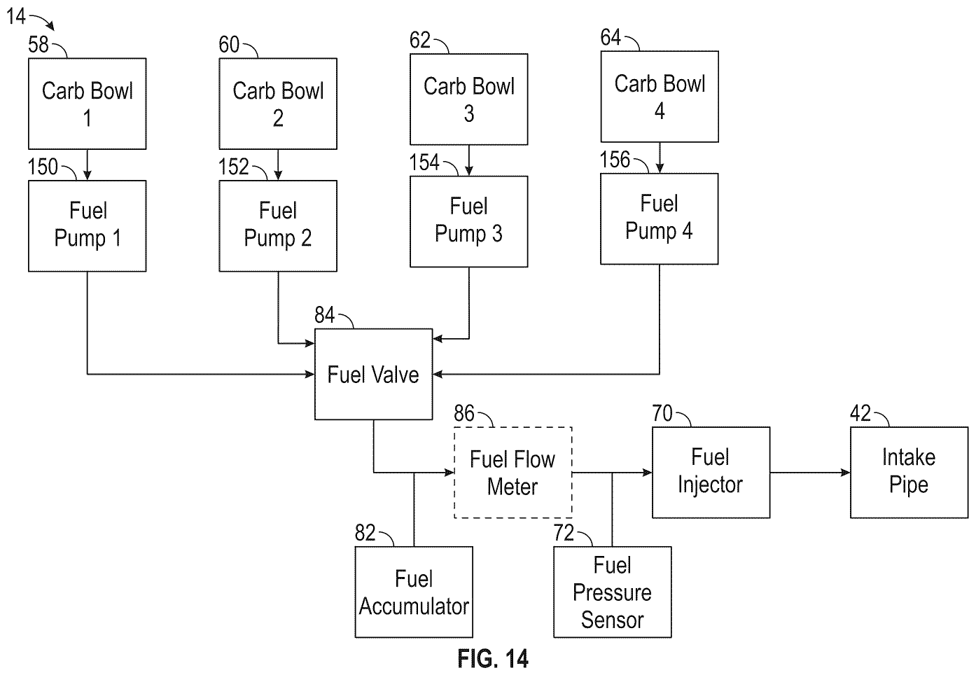

Turning to FIGS. 14-17, in some embodiments, the EFI system 14 includes a dedicated pump for each of the four carburetor bowls 58-64, rather than a single fuel pump (e.g., the fuel pump 68). Specifically, the EFI system 14 includes a first fuel pump 150 that pumps fuel from the first carburetor bowl 58 to the fuel selector valve 84, a second fuel pump 152 that pumps fuel from the second carburetor bowl 60 to the fuel selector valve 84, a third fuel pump 154 that pumps fuel from the third carburetor bowl 62 to the fuel selector valve 84, and a fourth fuel pump 156 that pumps fuel from the fourth carburetor bowl 64 to the fuel selector valve 84. Each of the first fuel pump 150, the second fuel pump 152, the third fuel pump 154, and the fourth fuel pump 156 is in communication with the HMI 16 and are individually controller (e.g., by a controller of the HMI 16) to output fuel to the fuel selector valve 84 at a predefined pressure.

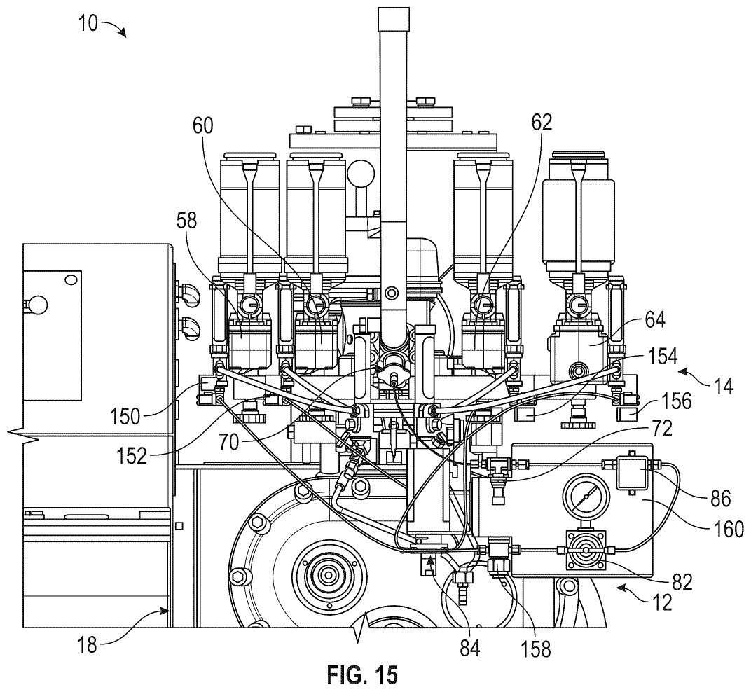

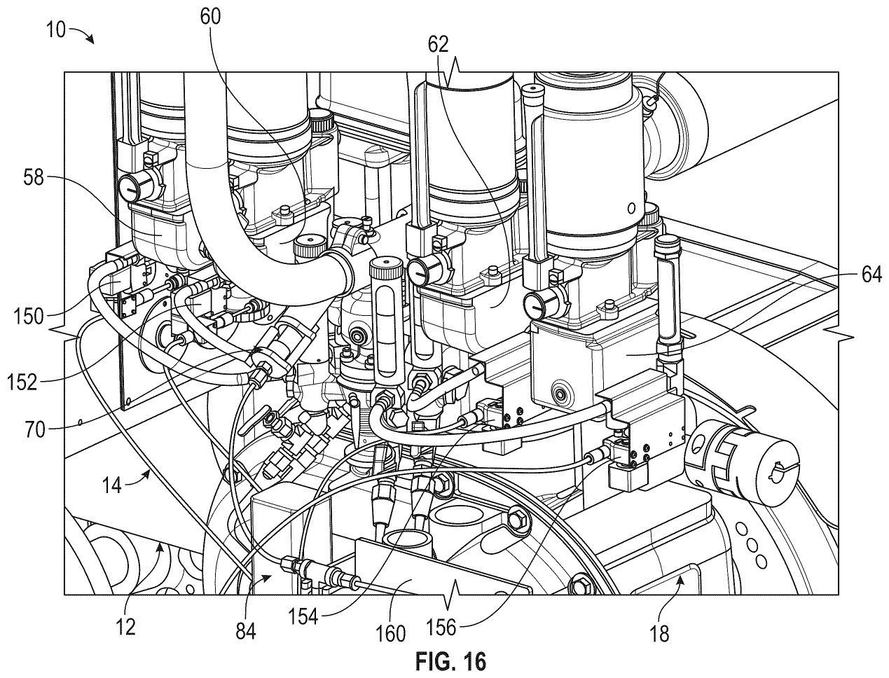

With specific reference to FIGS. 15 and 16, each of the first fuel pump 150, the second fuel pump 152, the third fuel pump 154, and the fourth fuel pump 156 is mounted below the respective carburetor bowl that it pumps fuel from. In some embodiments, each of the first fuel pump 150, the second fuel pump 152, the third fuel pump 154, and the fourth fuel pump 156 is coupled to a respective one of the four carburetor bowls 58-64 via a mounting bracket. An outlet of each of the first fuel pump 150, the second fuel pump 152, the third fuel pump 154, and the fourth fuel pump 156 is in fluid communication with a fuel line that is connected to a respective one of the four inlets of the fuel selector valve 84. The outlet of the fuel selector valve 84 is in fluid communication with a fuel filter 158, and an outlet of the fuel filter 158 is in fluid communication with the fuel accumulator 82. The outlet of the fuel accumulator 82 is in fluid communication with the fuel flow meter 86, and the fuel pressure sensor 72 measures a pressure of the fuel downstream of the fuel flow meter 86. From the fuel flow meter 86, the fuel flows to the fuel injector 70 within the injector coupling assembly 100.

In the illustrated embodiment, the fuel pressure sensor 72, the fuel accumulator 82, the fuel flow meter 86, and the fuel filter 158 are coupled to a mounting plate 160. The mounting plate 160 is mounted on and/or coupled to a housing of the octane test engine 12 (e.g., to the crankcase 18). In this embodiment, the octane test engine EFI system 14 may not include the cabinet 120 for mounting of the fuel selector valve 84. Rather, the fuel selector valve 84 is coupled to the octane test engine 12 by a bracket (e.g., a dedicated bracket and/or the mounting plate 160).

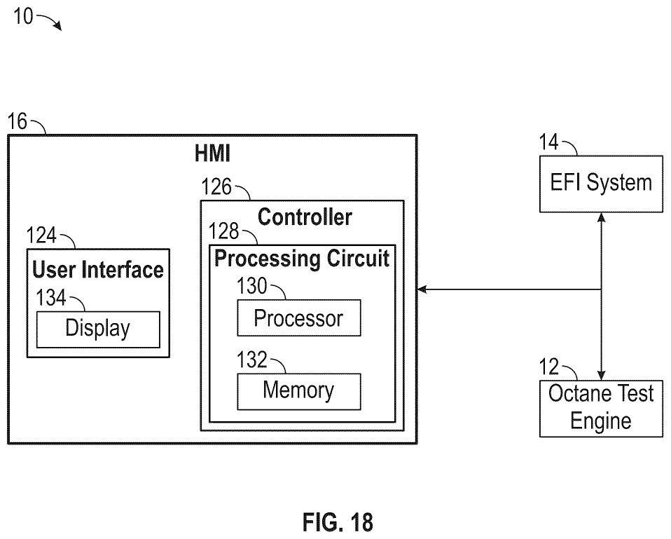

Turning to FIG. 18, the HMI 16 includes a user interface 124 and a controller 126 in communication with the user interface 124 having a display 134, the octane test engine 12, and the EFI system 14. The controller 126 includes a processing circuit 128 having a processor 130 and memory 132. The processing circuit 128 can be communicably connected to a communications interface such that the processing circuit 128 and the various components thereof can send and receive data via the communications interface. The processor 130 can be implemented as a general-purpose processor, an application specific integrated circuit (“ASIC”), one or more field programmable gate arrays (“FPGAs”), a group of processing components, or other suitable electronic processing components.

The memory 132 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 132 can be or include volatile memory or non-volatile memory. The memory 132 can include database components, object code components, script components, or any other type of information structure for supporting the various activities and information structures described in the present application. According to some embodiments, the memory 132 is communicably connected to the processor 130 via the processing circuit 128 and includes computer code for executing (e.g., by the processing circuit 128 and/or the processor 130) one or more processes, methods, or procedures described herein.

In general, the controller 126 is in communication with the octane test engine 12, the EFI system 14, and the user interface 124 and configured to receive various data inputs from the octane test engine 12, the EFI system 14, and the user interface 124, and supply output control signals to the octane test engine 12 and/or the EFI system 14. For example, the controller 126 is configured to receive data inputs from the temperature sensors 50, the fluid pressure sensors 52, the knock sensor 54, the crank angle encoder 74, the cam sensor 76, the AFR sensor 78, the temperature/pressure sensor 80, the fuel flow meter 86 (if present), the mass airflow sensor 88 (if present), the exhaust temperature sensor 96 (if present). In some embodiments, the controller 126 is configured to supply output control signals to control operation of the spark plug 55, the fuel pump 68, the fuel injector 70, the fuel selector valve 84, and the fan driver 92 (if present).

The incorporation of the EFI system 14 into the octane number rating system 10 enables the determination of an octane number of a sample fuel relative to two known primary reference fuels according to the procedures outlined in ASTM D2699 and ASTM D2700. For example, the flow rate from the fuel injector 70 is controlled to match the flow rate change from the carburetor that traditionally takes place during the procedures outlined in ASTM D2699 and ASTM D2700. The measurement and operation would be identical to the carburetor, with the maximum knock intensity measured by the knock sensor 54 being recorded as the fuel flow rate (level) is incrementally adjusted by the fuel injector 70 in the same steps as traditionally performed by the carburetor. The AFR sensor 78 may be used to ensure the fuel flow rate (if the fuel flow meter 86 is not used) and ensure that change in fuel flow rate matches the predetermined rate of the carburetor.

The incorporation of the EFI system 14 on the octane test engine 12 enables AFR to be utilized as a control parameter (e.g., rather than fuel flow rate) during the octane ratine procedures. By commanding a specific AFR, the controller 126 is configured to command the fuel injector 70 to adjust the fuel flow rate (e.g., via pulse-width modulation) so that the commanded AFR is obtained. In this way, for example, the EFI system 14 is able to compensate for oxygenated fuel, elevation changes, and intake air temp changes, which conventional octane rating systems are not capable of.

ASTM D2699 and ASTM D2700 both includes procedures where the engine is allowed to reach equilibrium at a particular fuel flow rate, and then the fuel flow rate is changed, in predetermined step changes, and the engine is allowed to again reach equilibrium. This process is repeated until a peak knock intensity is reached. Using the EFI system 14, a specific AFR is input to the HMI 16 (e.g., to the user interface 124) and the controller 126 controls the amount of fuel supplied to the octane test engine 12 by the fuel injector 70 so that the commanded AFR is achieved. The equilibrium procedure, similar to that specified in ASTM D2699 and ASTM D2700, is performed by the EFI system 14 by incrementally changing the AFR in predetermined steps (e.g., 0.25 AFR, 0.5 AFR, etc.). For example, an octane rating procedure may initiate at a first AFR and a knock intensity value is captured by the knock sensor 54 at the first AFR once one or more engine operating parameters (e.g., AFR, exhaust temperature, speed, etc.) are determined to be stable. The AFR is then commanded to a second AFR that is richer (i.e., more fuel) than the first AFR by a predetermined increment (e.g., 0.25 AFR, 0.5 AFR) and another knock intensity value is captured once the engine is stable. This process is repeated until a maximum knock intensity is captured and then the entire process is repeated for additional fuels (e.g., primary reference fuels) to determine an octane number for a sample fuel.

ASTM D2699 and ASTM D2700 both includes procedures using the carburetor where the fuel is allowed to fall (falling level) and the knock intensity is measured by the knock sensor 54 is monitored and the peak naturally occurs while the fuel level falls (e.g., from rich to lean). The incorporation of the EFI system 14 enables an improvement on the falling level procedure that improves the accuracy and precision of the octane number rating procedure, and allow the knock intensity to be correlated to a standardized engine parameter (e.g., AFR). For example, an octane rating procedure may initially start at a first AFR (e.g., 11:1) and transition to a second AFR (e.g., 17:1) that is leaner (i.e., more air) than the first AFR at a predetermined rate (e.g., 0.5 AFR/min, 1 AFR/min, 1.5 AFR/min). The controller 126 is configured to adjust the fueling provided by the fuel injector 70 during this falling level procedure at the predetermined rate, and the pulse width is adjusted to compensate for air density or additional oxygen in the fuel. Knock intensity values are captured by the knock sensor 54 during the falling rate procedure at predetermined time periods and the maximum knock intensity is determined. This process is repeated for additional fuels (e.g., primary reference fuels) to determine an octane number for a sample fuel.

In some embodiments, an octane rating procedure may include initially injecting the fuel via the fuel injector 70 at an initial AFR value (e.g., about 10, 10.5, 11, etc.). The octane test engine 12 is allowed stabilize based upon AFR variance and then average a predetermined number of cycles (e.g., 100 cycles, 200 cycles, 300 cycles, etc.) of data for the recorded knock intensity measured by the knock sensor 54. Once the knock intensity measurement at the initial AFR value is taken, the fuel injector 70 is instructed to decrease the amount of fuel (i.e., increase the AFR value) to a second AFR value (e.g., 10.5, 11, 11.5, etc.). Again, the octane test engine 12 is allowed to stabilize for the predetermined number of cycles before taking a knock intensity measurement by averaging the predetermined number of cycles of data recorded by the knock sensor 54.

After the first two knock intensity measurements, the controller 126 may then look at a slope of the line between the two points (e.g., first knock intensity as a function of initial AFR vs. second knock intensity as a function of second AFR) and determine the next rate of fueling based upon the slop of the line. In general, the initial AFR is selected so that the AFR is a predetermined amount rich of stoichiometric to ensure that the initial AFR is too rich for the maximum knock intensity and that leaning out the AFR (increasing the AFR) will eventually reach the maximum knock intensity. After the controller 126 determines how much to decrease the fueling based on the slope of the line between the first two knock intensities the controller 126 may then instruct the fuel injector 70 to incrementally decrease fueling rate to a third air-fuel ratio and take another data point (knock intensity) at the third air-fuel ratio. The controller 126 may then determine based on the slope of the line between the second knock intensity and the third knock intensity (i.e., the two most-recent knock intensity measurements) the next decrease in fuel rate and the AFR. The controller 126 will continue to take knock intensity measurements and iteratively decrease the fueling rate and AFR as the slope of the line between the two most-recent knock intensities decreases, with the fuel rate steps get smaller as the slope of the line becomes flatter (i.e., approaches zero indicating that the peak of the knock intensity curve is approaching). The maximum knock intensity is determined by continually reducing the fueling rate supplied by the fuel injector 70, which leans out the AFR, until the slope of the line drops to a negative slope and the knock intensity drops off. Once the measured knock index drops by more than a predetermined percentage (e.g., 2%, 3%, etc.) from the maximum value, the controller 126 may purge the fuel lines, then instruct the fuel selector valve 84 to switch to the next fuel, and perform the above-described iterative AFR procedure again. It should be appreciated that the slope-based approach may also be implemented by starting lean (e.g., AFR 17:1) and decreasing the AFR (increasing fueling).

In some embodiments, the EFI system 14 and the controller 126 are configured to perform an octane rating procedure that uses the fuel injector 70 as the metering device, rather than the AFR sensor 78. For example, an octane rating procedure includes instructing the fuel injector 70 to supply fuel to the octane test engine 12 at a first fuel flow rate and measuring a knock intensity with the knock sensor 54. The controller 126 then instructs the fuel injector 70 to change the fuel flow rate (e.g., increase if starting lean of stoichiometric, or decrease if starting rich of stoichiometric) in predetermine increments until a maximum knock intensity is reached.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the octane number rating system 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An electronic fuel injection system for an octane number rating system, the octane number rating system including an octane test engine having an intake pipe, an exhaust port, and a carburetor with a venturi arranged downstream of the intake pipe, the electronic fuel injection system comprising:
an electronic fuel pump;
an electronic fuel injector in fluid communication with an outlet of the electronic fuel pump, wherein the electronic fuel pump is configured to supply pressurized fuel from a carburetor bowl to the electronic fuel injector, and wherein the electronic fuel injector is coupled to the intake pipe upstream of the venturi; and
an air-fuel ratio sensor configured to measure an air-fuel ratio within or downstream of the exhaust port.

2. The electronic fuel injection system of claim 1, wherein the electronic fuel pump is controlled by pulse width modulation to maintain a predetermined fuel pressure based on a fuel pressure measured by a fuel pressure sensor.

3. The electronic fuel injection system of claim 2, wherein a fuel accumulator is arranged between the electronic fuel pump and the fuel pressure sensor.

4. The electronic fuel injection system of claim 1, wherein the octane test engine includes a plurality of carburetor bowls and the electronic fuel injection system further comprises a plurality of electronic fuel pumps, each being arranged to pump fuel from a corresponding one of the plurality of carburetor bowls.

5. The electronic fuel injection system of claim 4, wherein each of the plurality of electronic fuel pumps is arranged upstream of a fuel selector valve.

6. The electronic fuel injection system of claim 1, wherein the air-fuel ratio sensor is a wide-band air-fuel ratio sensor.

7. The electronic fuel injection system of claim 1, further comprising a controller in communication with the electronic fuel injector and the air-fuel ratio sensor, wherein the controller is configured to adjust a pulse width of a signal supplied to the electronic fuel injector based on an operating air-fuel ratio measured by the air-fuel ratio sensor.

8. The electronic fuel injection system of claim 1, further comprising a fan in communication with the intake pipe, wherein the fan is controlled by pulse width modulation to compensate for changes in barometric pressure.

9. A method for determining an octane number of a sample fuel, the method comprising:
instructing an octane test engine to operate at a first air-fuel ratio;
controlling an electronic fuel injector so that the octane test engine operates at the first air-fuel ratio;
measuring an operating air-fuel ratio of the octane test engine with an air-fuel ratio sensor;
measuring a first knock intensity that corresponds with the first air-fuel ratio;
instructing the octane test engine to operate at a second air-fuel ratio;
changing, via the electronic fuel injector, operation of the octane test engine so that the octane test engine operates at the second air-fuel ratio;
measuring a second knock intensity that corresponds with the second air-fuel ratio;
continuing to change the operating air-fuel ratio of the octane test engine, via the electronic fuel injector, until a maximum knock intensity is detected.

10. The method of claim 9, wherein the air-fuel ratio sensor is a wide-band air-fuel ratio sensor.

11. The method of claim 9, wherein the first air-fuel ratio is richer than the second air-fuel ratio.

12. The method of claim 11, wherein instructing the octane test engine to operate at the second air-fuel ratio comprises:
instructing the electronic fuel injector to increase from the first air-fuel ratio to the second air-fuel ratio at a predetermined rate.

13. The method of claim 9, wherein the first air-fuel ratio is leaner than the second air-fuel ratio.

14. The method of claim 13, wherein instructing the octane test engine to operate at the second air-fuel ratio comprises:
instructing the electronic fuel injector to decrease from the first air-fuel ratio to the second air-fuel ratio in a predetermined increment.

15. The method of claim 9, wherein continuing to change the operating air-fuel ratio of the octane test engine, via the electronic fuel injector, until a maximum knock intensity is detected comprises:
continuing to iteratively increase, via the electronic fuel injector, the operating air-fuel ratio based on a slope of a line that includes two most-recent knock intensities until the slope of the line becomes negative, wherein an amount that the operating air-fuel ratio decreases becomes smaller as the slope of the line approaches zero.

16. The method of claim 9, further comprising:
supplying pressurized fuel to the electronic fuel injector with an electronic fuel pump.

17. The method of claim 16, further comprising:
measuring, via a fuel pressure sensor, a fuel pressure of the pressurized fuel supplied to the electronic fuel injector; and
adjusting operation of the electronic fuel pump to maintain a predetermined pressure of the pressurized fuel.

18. A method for determining an octane number of a sample fuel, the method comprising:
operating an octane test engine at an initial air-fuel ratio;
measuring a first knock intensity that corresponds with the initial air-fuel ratio;
decreasing, via an electronic fuel injector, an air-fuel ratio to a second air-fuel ratio;
measuring a second knock intensity that corresponds with the second air-fuel ratio;
measuring a slope of a line that includes the first knock intensity and the second knock intensity;
determine an amount to decrease the air-fuel ratio based on the slope of the line; and
decreasing, via the electronic fuel injector, the air-fuel ratio by the amount to a third air-fuel ratio;
measuring a third knock intensity that corresponds with the third air-fuel ratio; and
continuing to iteratively increase, via the electronic fuel injector, the air-fuel ratio based on a slope of a line that includes two most-recent knock intensities until the slope of the line becomes negative, wherein the amount that the air-fuel ratio increases becomes smaller as the slope of the line approaches zero.

19. The method of claim 18, further comprising:
measuring, via a wide-band air-fuel ratio sensor, the initial air-fuel ratio, the second air-fuel ratio, and the third air-fuel ratio.

20. The method of claim 18, further comprising:
supplying pressurized fuel to the electronic fuel injector with an electronic fuel pump;
measuring, via a fuel pressure sensor, a fuel pressure of the pressurized fuel supplied to the electronic fuel injector; and
adjusting operation of the electronic fuel pump to maintain a predetermined pressure of the pressurized fuel.
